(19) United States
(12) Patent Application Publication
(10) Pub. No.: US 2005/0268522 A1
(43) Pub. Date: Dec. 8, 2005

(54) Adapter stand for use with a buoyant waterfowl decoy, kit including the adapter stand, and method of using same

(75) Inventors: David Larry Foster, Charlotte, MI (US); Robert Butcher, Flushing, MI (US)

Correspondence Address: CARRIER BLACKMAN AND ASSOCIATES, 24101 NOVI ROAD, SUITE 100, NOVI, MI, 48375, US

(73) Assignee: Eastman Holding Company, Flushing, MI (US)

(21) Appl. No.: 11/136,301

(22) Filed: May 24, 2005

Related U.S. Application Data
(60) Provisional application No. 60/574,244, filed on May 25, 2004.

(51) Int. Cl. A01M 31/06

(52) U.S. Cl. 43/3

(57) ABSTRACT

A decoy adapter stand allows a floatable buoyant waterfowl decoy to be adapted for use on land. The decoy adapter stand includes an upper securing bracket, a base, and a vertical spacer joining the upper bracket to the base. The securing bracket is used to secure a floatable buoyant waterfowl decoy to the stand, and the base provides a stable support. In use, the vertical spacer distances the decoy from the surface of the ground, so that the decoy appears to be standing. A first, freestanding embodiment of the decoy adapter stand includes a footed base. A second embodiment of the decoy adapter stand includes a staked base, where portions of the base are insertable into the ground. A method of using the described apparatus to adapt a floatable buoyant decoy for land use is also described.

### CROSS-REFERENCE TO RELATED APPLICATIONS

The present invention claims priority under 35 USC 119(e) based on U.S. provisional patent application No. 60/574,244, filed May. 25, 2004.

### BACKGROUND OF THE INVENTION

1. Field of the Invention

The present invention relates to waterfowl decoys and related accessories. More particularly, the present invention relates to an adapter stand, which is usable with a buoyant waterfowl decoy, to allow a hunter to adapt the waterfowl decoy for land use. The present invention also relates to a kit including the novel adapter stand and a buoyant waterfowl decoy, as well as to a method of using the described adapter stand to modify and adapt a buoyant waterfowl decoy for land use.

2. Background Art

A variety of animal decoys are known and used by hunters, for placement in field environments to attract wild game. Many different decoys are known for simulating many different types of animals, in many types of environments.

For example, waterfowl decoys are used to attract waterfowl into the target range of a hunter. Many types of waterfowl decoys have been developed over the years to improve hunters' chances of attracting game, and these known decoys are designed for use either in an aquatic environment or on land, but not both.

Some examples of buoyant three-dimensional decoys, and accessories therefor, are described in U.S. Pat. Nos. 3,733,733, 5,172,507, 5,832,650, 5,899,014, and 6,543,176.

For example, floatable buoyant decoys of one known style, such as the decoy 1 shown in FIG. 1, typically consist of a hard-shell housing 7 formed in the shape of a simulated waterfowl, and are often provided with a weighted bar or keel 8 along the underside of the housing 7.

This keel 8 may include a metal bar, or may be a hollow tube filled with pelletized metal weights (not shown) to properly orient and stabilize the decoy when it is floating in water. The keel 8 is essential to keeping the floatable buoyant decoy 1 upright when in water, but unfortunately, prevents the decoy from remaining upright when the decoy rests on land. The conventional decoy 1 shown in FIG. 1 has a narrow portion formed between widest part of the keel 8 and the housing 7, defining a recessed groove or channel 9 at the top of the keel on each side thereof.

It is also difficult to use decoys designed for land use in water applications. These may include two-dimensional silhouette decoys, which are normally staked in place (FIG. 2), or three-dimensional decoys, which are either self-supporting or require external support.

Thus, hunters are required to acquire different decoys for each environment in which they intend to hunt. This incurs both increased cost and inconvenience, since multiple decoys must be stored, maintained, and transported to and from the hunting site.

A limited number of adapter stands, for supporting decoys, are known in the art. For example, U.S. Pat. No. 6,655,071 to Barnes et al., U.S. Pat. No. 6,442,884 to Sceery, and U.S. Pat. No. 6,266,912 to Jirele each disclose mounting devices used to support waterfowl decoys. However, the inventor is unaware of any prior art that relates to or discloses a decoy adapter stand that adapts a floatable buoyant animal decoy for land use.

A need still exists for a decoy adapter stand that can be used to adapt a floatable buoyant waterfowl decoy for land use, so that a single decoy can be used both on land and in water. A need also exists for a decoy adapter stand that is easy to use, regardless of land and weather conditions. A need exists for a decoy adapter stand that is easy and inexpensive to manufacture, so that it can be affordably priced.

### SUMMARY OF THE INVENTION

The present invention provides a decoy adapter stand which allows a floatable buoyant decoy to be adapted for use on land, thus allowing a hunter to use a single decoy in different environments. When using the decoy adapter stand hereof, a single decoy can be adapted for use in multiple environments, thereby reducing equipment costs, and also reducing transportation and storage requirements for this equipment.

In a first illustrative embodiment of the present invention, the inventive decoy adapter stand includes an upper bracket for use in securing a decoy to the stand, a base to provide stable support on land, and a spacer extending between the base and the bracket. The upper bracket and base are joined together by the vertical spacer, which distances the decoy upwardly from the ground surface, so that the decoy appears to be standing upright.

When placed on the adapter stand hereof, portions of the upper bracket fit slidably into channels formed on the underside of the decoy, and the decoy rests on the upper bracket.

The decoy adapter stand hereof, in a first aspect of the invention, is provided in a freestanding embodiment, which includes a footed base. In this first embodiment, the decoy adapter stand rests on the surface of the ground, and is especially well suited for frozen or rocky ground conditions.

In a second aspect of the present invention, a decoy adapter stand is provided in a fixably mountable embodiment including a base with a stake extending downwardly thereon. In this second embodiment of the invention, the stake portion of the base is adapted to be embedded in the ground, to temporarily fix the decoy in place.

Both embodiments are easy to use regardless of land or weather conditions, and both embodiments are of simple, curved rod design allowing for easy and economical manufacture.

The present invention also relates to a decoy kit, which includes a floatable buoyant waterfowl decoy having a keel, and an adapter stand which is attachable to the keel to allow the decoy to be used on land.

The present invention further relates to method of adapting a floatable buoyant decoy for land use by attaching the inventive adapter stand hereof to a keel portion of the decoy.

For a more complete understanding of the present invention, the reader is referred to the following detailed description section, which should be read in conjunction with the accompanying drawings. Throughout the following detailed description and in the drawings, like numbers refer to like parts.

### BRIEF DESCRIPTION OF THE DRAWINGS

FIG. 1A is a side plan view of a floatable buoyant prior art decoy, illustrating the use of a weighted keel at the underside of the decoy.

FIG. 1B is a front plan view of a floatable buoyant prior art decoy, also including a weighted keel at the underside of the decoy.

FIG. 2 is a side view of a two-dimensional silhouette-style prior art waterfowl decoy.

FIG. 3 is a front perspective view of a freestanding apparatus illustrating a floatable buoyant decoy resting on an adapter stand according to a first embodiment of the present invention.

FIG. 4 is a front perspective view of a staked apparatus illustrating a floatable buoyant decoy resting on an adapter stand according to a second embodiment of the present invention.

FIG. 5 is a top perspective view of an adapter stand according to the first embodiment hereof, illustrating a base portion having two horizontal parallel legs joined by a transverse horizontal cross bar.

FIG. 6 is a top perspective view of another adapter stand according to the first embodiment hereof, including a base portion having two horizontally oriented diverging legs.

FIG. 7 is a top perspective view of a stake post adapter stand according to the second embodiment hereof, including a threaded stake and a stabilizing arm.

FIG. 8 is a top perspective view of a decoy mounted on the adapter stand of FIG. 5.

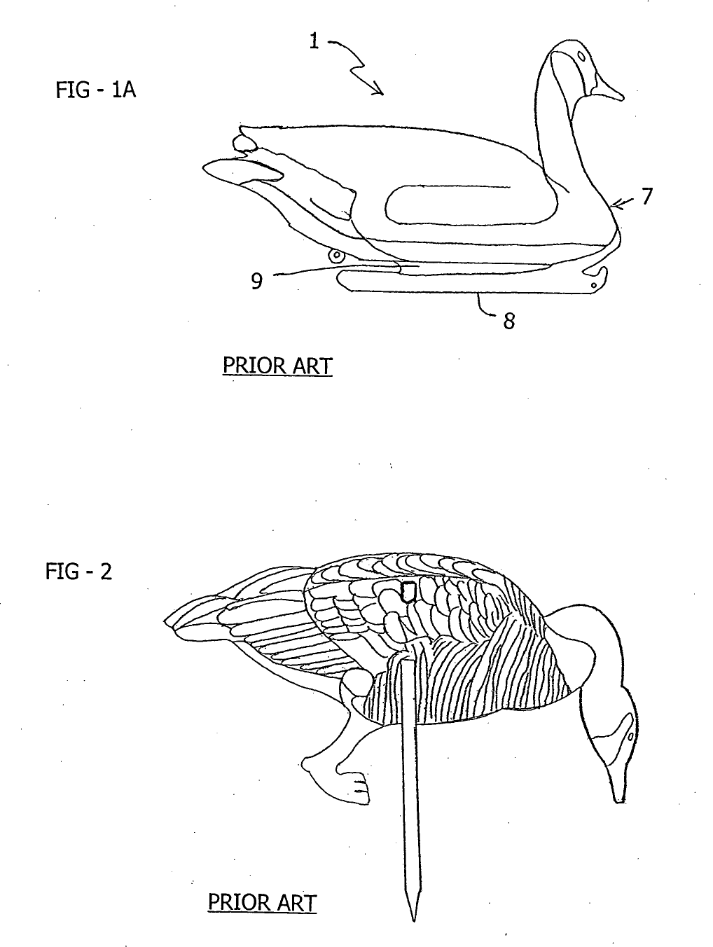

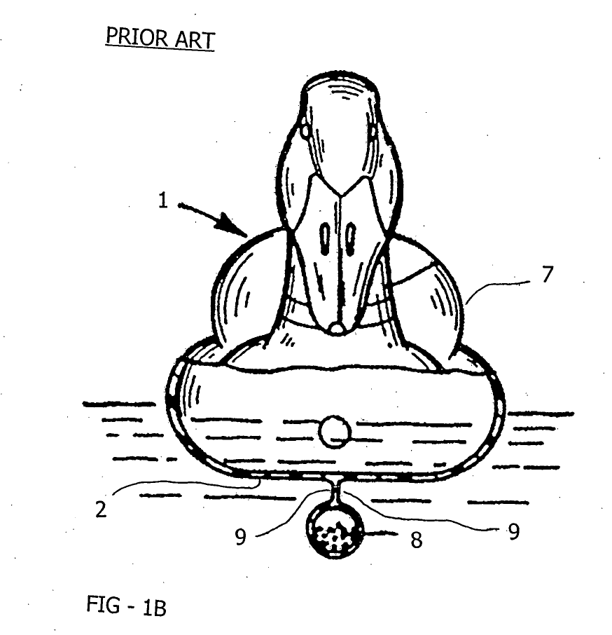

### DETAILED DESCRIPTION

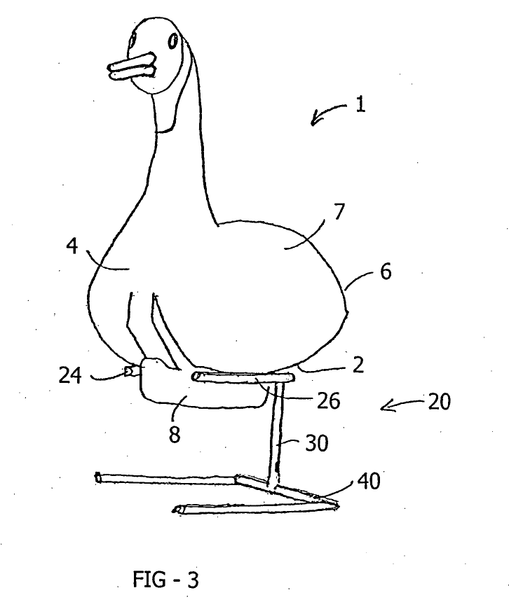

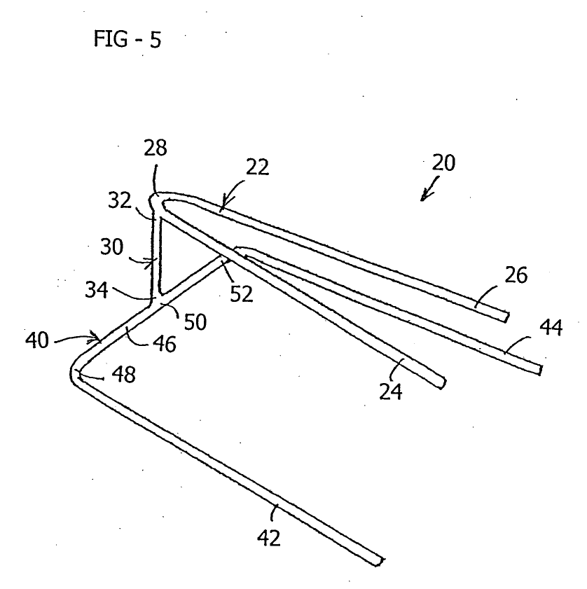

The apparatus for adapting a floatable buoyant decoy for land use and the method for using the apparatus will now be described in detail with respect to the drawing Figures. Referring now to FIGS. 3 and 5, a freestanding decoy adapter stand 20, according to a first illustrative embodiment of the present invention, is usable to support a floatable buoyant decoy 1. The decoy 1 is a conventional floatable buoyant decoy as described above, including a housing 7 formed in the shape of a waterfowl.

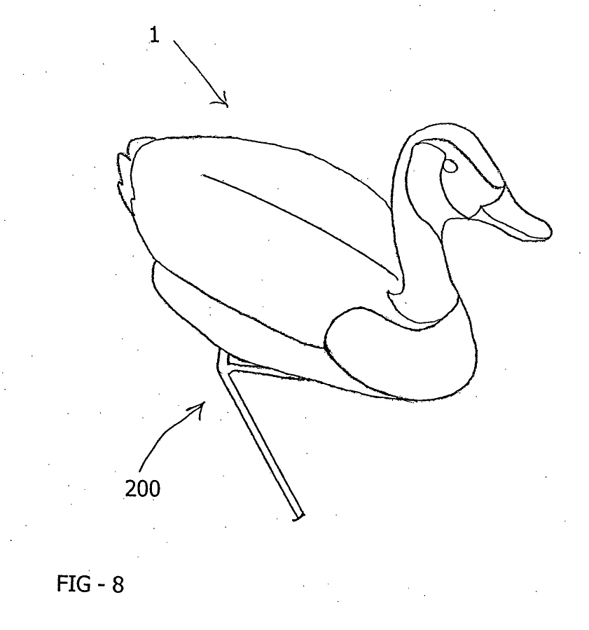

The decoy 1 is provided with a weighted keel 8 fixed to its underside 2. The keel 8 includes a bar that protrudes downwardly from the underside 2 of decoy 1, and extends in a direction from the front 4 to the rear 6 of decoy 1. Weighted keel 8 keeps decoy 1 upright when placed in water, and helps it to maintain its directional orientation while floating. The cross-sectional shape (FIG. 8) of the weighted keel 8 includes indented channels 9 formed in the bar adjacent underside 2, and extending along keel 8 from front 4 to rear 6 of decoy 1.

As best seen in FIG. 5, the first embodiment of the invention is a freestanding adapter stand 20 that includes an upper bracket 22, a spacer 30, and a footed base 40. A decoy 1 is shown mounted on and supported by the bracket 20 in FIG. 9.

The upper bracket 22 of the adapter stand 20 is used to interconnect the floatable buoyant decoy 1 and the decoy adapter stand 20. The upper bracket 22 is a bifurcated elongate rod formed into a V-shape, such that it has a first tine 24 and a second tine 26. The first tine and second tines 24, 26 intersect at an apex 28, and extend substantially perpendicularly to the spacer 30, such that the upper bracket 22 generally lies in the horizontal plane. Preferably, the first tine 24 and the second tine 26 are each provided in a length which is at least half the length of a decoy.

In use, the upper bracket 22 is aligned with and placed in back of the keel 8, and the tips of the respective tines 24, 26 are placed in the channels 9 on opposite sides of the keel. The decoy is then slid back as far as possible in the bracket 22. Alternatively, the decoy 1 may be held in place, and the adapter stand 20 may be slid along the keel as far as possible.

In the installed configuration thereof, the decoy housing 7 rests on top of the upper bracket 22, and the weighted keel 8 rests between and below the first and second tines 24, 26, which are received within the channels 9 formed in the keel 8. Preferably, the rear portion 6 of the decoy 1 overlies and covers the apex 28 of the upper bracket.

The integral spacer 30 connects the upper bracket 22 to the foot or base 40, and also vertically spaces the decoy 1 above the ground, so as to provide the impression of a standing waterfowl. Alternatively, a short spacer may be used, to provide the impression of a resting waterfowl.

In the embodiment of FIGS. 3 and 5, the spacer 30 is an elongate rod having an upper end 32 and a lower end 34. The upper bracket 22 is fixed to the upper end 32 of the spacer 30, and the lower end 34 of the spacer 30 is integrally attached to the base 40.

The base 40 is provided to supportively rest on the ground or other solid substrate, and functions to support and stabilize the spacer 30 and the upper bracket 22. In the first embodiment of the invention, the base 40 is provided with a first leg 42 and a second leg 44 that extend horizontally and are substantially parallel to one another.

A transverse cross bar 46 extends between and joins first leg 42 and second leg 44, such that the first end 48 of cross bar 46 is fixed to a first end of the first leg 42 and that the second end 52 of cross bar 46 is fixed to a first end of the second leg 44 so as to form a U shape. The mid portion 50 of cross bar 46 is fixed to the lower end 34 of the spacer 30. The base 40 extends perpendicularly from the spacer 30, such that the base 40 generally lies in a horizontal plane, and underlies the upper bracket 22.

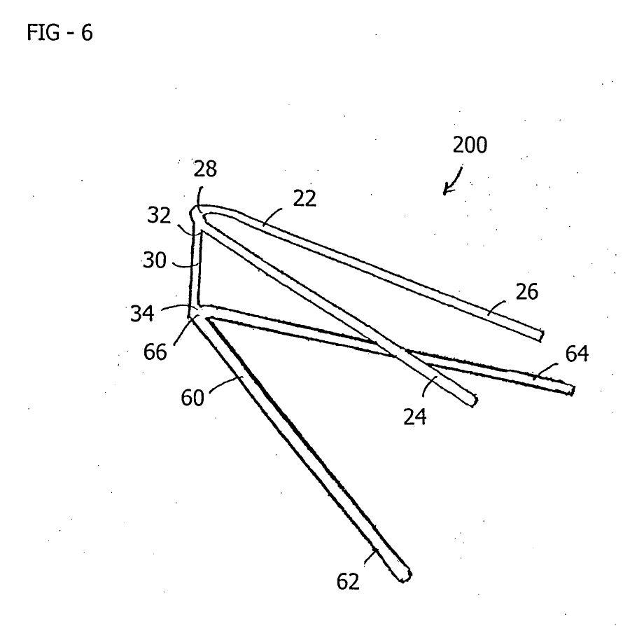

The freestanding decoy adapter stand 20 according to the first embodiment hereof can be provided with an alternative footed base configuration, as shown in FIG. 6. In the modified embodiment of a freestanding decoy adapter stand 200 shown in FIG. 6, the U-shaped base 40 is replaced by a substantially V-shaped base 60. The V-shaped base 60 is also provided for resting placement on a solid surface, and functions to support and stabilize upper bracket 22 and the spacer 30.

The base 60 is provided with a first leg 62 and a second leg 64 that extend in the horizontal plane and intersect to form an apex 66. Apex 66 of base 60 is fixed to the lower end of the spacer 30, such that the base 60 generally underlies the upper bracket 22.

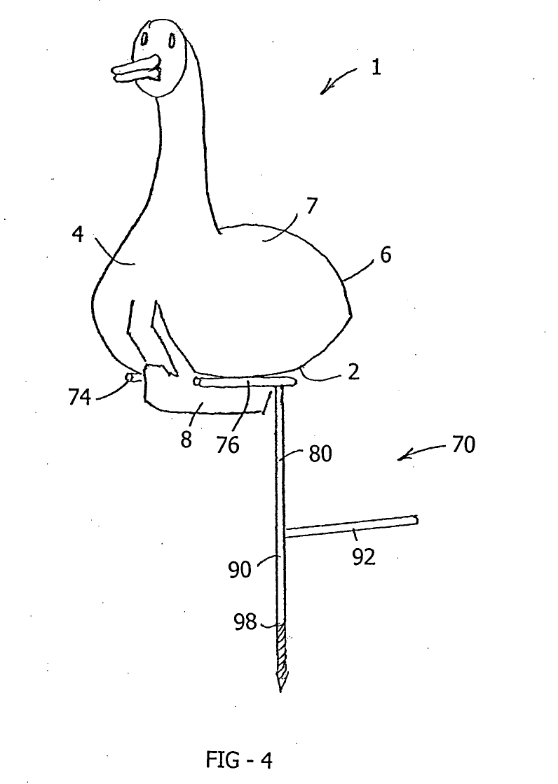

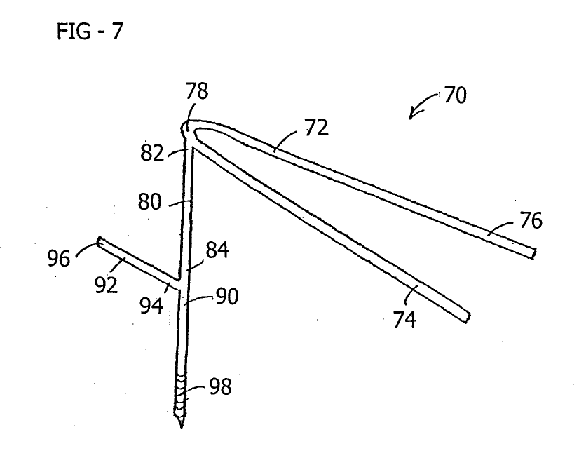

Referring now to FIGS. 4 and 7, a second embodiment of the invention will now be described. Staked decoy adapter stand 70 includes an upper bracket 72, a spacer 80, and a staked base 90. The upper bracket 72 is formed into a V-shape, such that it has a first tine 74 and a second tine 76 that intersect at an apex 78. The spacer 80 has an upper end 82 and a lower end 84. The spacer 80 and upper bracket 72 are identical to the components described above with respect to the footed, freestanding decoy adapter stand 20.

The staked base 90 is provided for anchored insertion within the ground, and functions to support and stabilize the upper bracket 22 and the spacer 30. The staked base 90 includes an anchor stake 98 and a stabilizer arm 92. Anchor stake 98 extends downwardly from lower end 84 of the spacer 80, and may be tapered adjacent its terminal end, such that the terminal end is pointed. The exterior surface of the anchor stake 98 may, optionally, be provided with external threads on the tip of the terminal end, to permit rotatable threaded installation into hard or frozen ground.

The stabilizer arm 92 is an elongate rod that extends integrally outwardly from a medial portion 84 of the spacer 90, in a direction substantially perpendicular to the spacer 90 and has a first end 96 and a second end 94. The stabilizer arm 92 lies generally horizontally and in a direction, which is opposed to the direction in which the upper bracket 72 extends, such that the stabilizer arm 92 does not underlie the upper bracket 72. The stabilizer arm 92 may be used as a footrest, to receive the foot of a user (not shown) thereon, and to allow the user to force the anchor stake 98 downwardly into the ground, weather permitting. The stabilizer arm 92 also acts as a stop bar to limit the distance to which the adapter 70 may be inserted in the ground.

In use, the anchor stake 98 of staked decoy adapter stand 70 is inserted into the ground to a depth at which stabilizer arm rests 92 on the surface of the ground.

The decoy adapter stand 20, 200, 70 according to the present invention may be formed of multiple joined sections of metal rod. Where metal rod is used to form the stand hereof, the upper bracket 22 and the base 40, 60, 90 are joined to the upright post of the spacer 30 by welding.

It is understood, however, that alternative materials, including but not limited to plastic, may be used to form the decoy adapter stand 20, 200, 70 hereof. When material properties allow, the inventive decoy adapter stand may be formed using alternative methods, such as die-casting.

A method for adapting a floatable buoyant waterfowl decoy for land use will now be described. To avoid the necessity and cost of owning and maintaining two separate decoys, one for water use and one for land use, the following method allows a single decoy to be used in both land-based and aquatic applications. This method uses the above-described inventive adapter stand and a conventional floatable buoyant animal decoy.

The method steps are as follows:

Step 1. Place the decoy adapter stand 20, 200, 70 on a solid surface such that base 40, 60, 90 confronts and abuts the solid surface, and such that the spacer 30 extends upward from the base 40, 60, 90. When freestanding decoy adapter stand 20, 200 is used, base 40, 60 rests on the solid surface. When staked decoy adapter stand 70 is used, the anchor stake 98 is inserted into the solid surface to a depth at which arm 92 confronts and abuts the solid surface.

Step 2. Secure the floatable buoyant animal decoy 1 to upper bracket 22 of decoy adapter stand 20, 200, 70 so that decoy housing 7 rests on the upper side of upper bracket 22, weighted keel 8 resides between first tine 24 and second tine 26, first and second legs 24, 26 are received within channels 9 formed in weighted keel 8 of decoy 1, and so that the rear 6 of decoy 1 overlies apex 28.

Positioning of first and second legs 24, 26 within channels 9 of weighted keel 8 secures decoy 8 to decoy adapter stand 20, 200, 70, and provides a means by which decoy 1 is prevented from becoming dislodged from decoy adapter stand 20, 200, 70 as might be caused by jostling, high winds or other unforeseen circumstances.

Alternatively, the upper bracket 22 of the adapter stand 20, 200, 70 may be aligned with the keel 8 of the decoy in a first step, the bracket 22 may be slid along the channels 9 as far as possible to mount the decoy 1 on the stand 20 in a second step, and the decoy and stand assembly may be placed on the ground in an upright configuration in a third step. Three different embodiments of upright configurations of the assembled decoy and stand are shown in FIGS. 3, 4 and 8. Where the staked embodiment of the adapter stand 70 is used, the method may include a step of forcing the stake 98 into the ground until the stabilizer arm 92 contacts the ground.

Although the presently contemplated embodiments of an apparatus for adapting a floatable buoyant decoy for land use, a waterfowl decoy kit, and methods of adapting a floatable buoyant decoy for land use have been described herein, the foregoing description is intended to illustrate, rather than to limit the invention. Those skilled in the art will recognize that various substitutions and modifications can be made, without departing from the invention. All such modifications, which are within the scope of the appended claims, are intended to be within the scope and spirit of the present invention.

1. An adapter stand apparatus for use with a floatable buoyant waterfowl decoy, said apparatus comprising a base, a securing bracket for securing the adapter stand to a decoy, and a vertical spacer interconnecting the securing bracket and the base:
wherein the vertical spacer has an upper end and a lower end,
wherein the securing bracket comprises a bifurcated rod comprising a first tine and a second tine, the first and second tines intersecting to form an apex, the apex of the securing bracket being fixed to the upper end of the vertical spacer; and
wherein the base comprises at least one leg affixed to the lower end of the vertical spacer and extending substantially transversely outwardly therefrom.

2. The apparatus of claim 1, wherein the base comprises a first leg, a second leg, and a cross bar which extends between and joins the first and second legs;
and wherein the cross bar comprises a midsection which is fixed to the lower end of the vertical spacer.

3. The apparatus of claim 1, wherein the base comprises a first leg and a second leg, the first and second legs intersecting to form an apex, which is affixed to the lower end of the vertical spacer.

4. The apparatus of claim 1, wherein
the base comprises a first leg and an anchor stake, the first leg attached to and extending substantially horizontally outwardly from the vertical spacer in a direction which is opposed to the direction in which the securing bracket extends, such that the first leg does not underlie the securing bracket;
and wherein the anchor stake extends linearly downwardly from the lower end of the vertical spacer.

5. The apparatus of claim 4, wherein the anchor stake has a tapered tip such that it terminates in a point, and wherein said tip has external threads formed thereon.

6. A decoy kit comprising the adapter stand of claim 1 in combination with a floatable buoyant decoy, wherein the decoy comprises a housing formed in the shape of a waterfowl, and a weighted keel secured to the lower side of the housing.

7. A method of adapting a floatable buoyant waterfowl decoy for land use, wherein the decoy comprises a housing formed in the shape of a waterfowl, and a weighted keel secured to the lower side of the housing, said method comprising the steps of:
a) resting a portion of said decoy adapter apparatus on a solid surface such that a vertical spacer of the adapter apparatus extends upwardly from a base portion of the apparatus, wherein said spacer apparatus comprises comprising a securing bracket, a base and a vertical spacer interconnecting the bracket and the base;
b) inserting the weighted keel of the decoy between respective first and second tines of said securing bracket such that the tines fit slidably in channels formed on the sides of said keel.

8. The method of claim 7, wherein steps a) and b) may be performed in any order.
